(19) United States
(12) Patent Application Publication
(10) Pub. No.: US 2009/0285094 A1
(43) Pub. Date: Nov. 19, 2009

(54) Apparatus and method for estimating the fill factor of client input buffers of a real time content distribution

(76) Inventors: Gilles Straub, Acigne (FR); Jean-Francois Fleury, Beijing (CN); Mary-Luc Champel, Marpire (FR)

Correspondence Address: Thomson Licensing LLC, P.O. Box 5312, Two Independence Way, PRINCETON, NJ, 08543-5312, US

(21) Appl. No.: 11/988,626

(22) PCT Filed: Jul. 11, 2006
(86) PCT No.: PCT/EP2006/064109

§ 371 Date: Feb. 6, 2009

(30) Foreign Application Priority Data
Jul. 11, 2005 (FR) 0552134

(51) Int. Cl. H04L 12/56

(52) U.S. Cl. 370/235

(57) ABSTRACT

The invention concerns a solution for detecting conditions of dearth and overflow of a client input buffer to a real time content distribution. Said detection is performed upstream of clients through a dynamic estimation of the fill factor of the input buffers of said clients. Thus, it is possible to predict the occurrence of dearth or overflow situations and to take actions such as inserting stored video sequences or storing queueing packets.

### 1. SCOPE OF THE INVENTION

The present invention relates to the field of digital content distribution from a server to clients. And more particularly, the context of video distribution on a distribution network such as the IP network.

### 2. TECHNOLOGICAL BACKGROUND

It is now common to distribute digital content such as music or video over packet switching distribution networks such as the IP network. Indeed, the development of the Internet network has led to the development of these techniques.

The distribution of digital content by servers to customers via an IP network. These networks are characterised by time distortions in the routing of packets commonly called “jitter” in the jargon of those skilled in the art. They are also subject to packet losses owing, for example, to congestion on intermediate gateways transmitting the data between the server and the customers. The recovery of the distributed content imposes constraints on the maximum authorised distortions.

To combat these distortions and these losses, the clients generally integrate an input buffer in which the received packets are stored. These buffers are then filled by the packets coming from the servers via the network, whereas the client empties them as the data is consumed by the content recovery. For a correct content recovery, these input buffers must not empty completely causing underflow in the buffer, nor fill up completely causing overflow in the buffer. Indeed, for underflow, the recovery will lack data and be interrupted. Whereas for overflow, the buffer will not be able to store packets arriving and will thus cause data loss, leading, here again, to interruptions in the recovery of the content.

According to the document entitled “Online smoothing of VBR streaming video” written by Subhabrata & Al in “IEEE transactions multimedia” in March 2000, a stream smoothing technique is implemented to prevent the underflow or overflow of the buffer memories of a device. Nevertheless, this technique is not optimised for the transmission of data in a network where the stream transmission time is poorly controlled (particularly the case of networks where a best effort technique is used).

The transmission on an IP network not offering any guarantees in terms of latency and packet loss, one can only ensure that these situations of famine or overflow cannot happen. In this case, it is interesting to be able to detect the occurrence of these situations in such a manner as to be able to take counter measures enabling the consequences of these problems to be removed or at least limited for the user.

It is known, for example in the patent JP09298734, to carry out a monitoring of the input buffer filling rate of a device at the level of the device itself. In the event of underflow or overflow, the device sends a warning to the server. Said server thus taking measures to deal with the problem arising.

This method of proceeding firstly involves a dialogue between the client and the server. This dialogue induces a latency between the detection of the problem and its recognition. Moreover, this recognition is generally possible only if the distribution of the content is carried out from the server to a single client, a unicast distribution. When the server distributes the same content to many clients, multicast distribution, the server can no longer take measures that will automatically concern all the clients to resolve a problem that arise for a single client.

### 3. SUMMARY OF THE INVENTION

The invention proposes a solution for detecting underflow and overflow situations of the input buffer of a client at a real time distribution of content. This detection is carried out upstream of the clients by a dynamic estimation of the filling rate of the input buffers of this clients. In this manner, it is possible to predict the occurrence of underflow or overflow situations and to take measures such as the insertion of stored video sequences or the memorisation of waiting packets.

The invention relates to a device that can be connected to a content distribution network by packets, the content being sent in the form of a stream of digital data intended for at least one client, the at least one client having an input buffer in which it stores the data received before decoding it with a view to recovering the content the device having means to transit the data packets between the distribution network and the at least one client, connected to the said distribution network, these means to transit data packets transiting all the packets intended for the buffer of the client, the device comprising calculation means of an estimation of the filling rate of the input buffer of the at least one client according to at least one parameter of the said client. The at least one parameter of the client is, for example taken from the following parameters:
the size of the input buffer of the at least one client connected to the distribution network,
the quantity of data that the at least one client stores before triggering the decoding when it receives a data stream,
the recovery bit-rate that the at least one client uses to empty the input buffer.

To prevent the device from displaying an unwanted content (for example a black screen or fixed image), according to the invention, the device is suitable to send to a client a content replacement sequence when the estimated filling rate of the input buffer crosses below a threshold.

According to one particular embodiment, the device also comprises real-time content replacement sequence storage means.

According to one particular embodiment, the device is suitable to temporarily store the data packets intended for a client for which the estimation of the filling rate of its input buffer crosses above a threshold.

According to one particular embodiment, the device is suitable to send a warning message when the estimation of the filling rate of a client crosses below a threshold.

According to one particular embodiment, the device is suitable to send a warning message when the estimation of the filling rate of a client crosses above a threshold.

The invention also relates to a method for estimating the filling rate of the input buffer of a decoding device of a content sent in the form of a stream of digital data, called client, by a surveillance device that can be connected to a content distribution network by packet switching, the surveillance device having means to transit the data packets between the distribution network and the client connected to the said distribution network, these means to transit data packets transiting all the data packets between the client and the distribution network, this method comprising a step for calculating an estimation of the filling rate of the input buffer of the at least one client according to the size of its input buffer, the quantity of data that it stores before triggering the decoding and the data packets having transited through the said surveillance device intended for the at least one client.

To prevent the device from displaying an unwanted content, according to the invention, the method comprises a send operation to a client, of a content replacement sequence when the estimated filling rate of the input buffer of the client crosses below a threshold.

According to one particular embodiment, the calculation of the estimation of the filling rate is carried out in a regular manner.

According to one particular embodiment, the calculation of the estimation of the filling rate is carried out each time a data packet is sent to the client.

According to one particular embodiment, the method moreover comprises a step of sending a stored sequence when the estimation of the filling rate crosses below a threshold.

According to one particular embodiment, the method moreover comprises a step for temporarily storing the data packets intended for a client for which the estimation of the filling rate of its input buffer crosses above a threshold.

According to one particular embodiment, the method moreover comprises a step of sending a warning message when the estimation of the filling rate of a client crosses below a threshold.

According to one particular embodiment, the method also comprises a step of sending a warning message when the estimation of the filling rate of a client crosses above a threshold.

### 4. DESCRIPTION OF THE FIGURES

The invention will be better understood, and other specific features and advantages will emerge from reading the following description, the description making reference to the annexed drawings wherein:

FIG. 1 shows the content distribution architecture according to the embodiment of the invention.

FIG. 2 shows a detail of this architecture highlighting the prediction of the filling of the buffers in the embodiment.

FIG. 3 represents the hardware architecture of a device implementing the embodiment of the invention.

### 5. DETAILED DESCRIPTION OF THE INVENTION

The invention relates to all types of real-time digital content distribution on packet switching networks. The embodiment lies within the more specific framework of video distribution on an IP network, such as for example Internet or a dedicated distribution network.

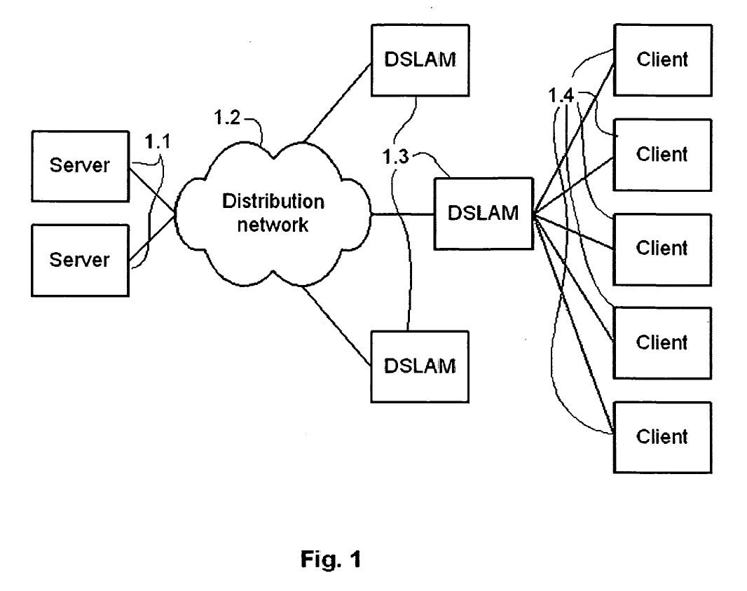

An example of architecture reflecting the framework of the embodiment is shown in FIG. 1. In this figure, one can see servers, referenced 1.1, of real-time digital content distribution. These servers are connected to a distribution network referenced 1.2. The embodiment is located within the framework when the final clients, referenced 1.4, are connected to the distribution network via ADSL technology (Asynchronous Digital Subscriber Line). This technology enables the high bit-rate connection of the client to the distribution network via the telephone line. To do this, the telephone exchange is equipped with an item of connection equipment called DSLAM, referenced 1.3, (Digital Subscriber Line Access Multiplexer. These DSLAMs being connected to the distribution network, they jointly enable an ADSL modem at the client to multiplex the digital connection and the voices accesses on the telephone line. In this manner, each client, via the DSLAM, is connected to the content distribution network. Although the embodiment of the invention lies within the framework of an ADSL access of the client to the distribution network, the invention is not limited to this framework and operates in the same manner on any type of connection between the client and the distribution network. Moreover, the invention is not necessarily implemented in a DSLAM but, on the contrary, can be implanted in any device transiting data packets between a distribution network (for example, internet network or ADSL network) and the buffer memory of at least one client connected to the distribution network. Advantageously, the link between the device and the buffer memory of a client does not experience interference affecting the filling rate of this buffer memory (particularly interference of the jitter or packet loss type). This is for example a point-to-point link to the client or a local area network entry point (for example, domestic network) to which the client belongs.

The server contains, or is capable of generating, files of digital data, typically of audio and video services. These files are distributed in the form of real-time data streams encoded according to the MPEG standard (Moving Picture Engineering Group). According to this standard the data is divided into packets, these packets being then distributed over the network to the clients. The multicast broadcast mode consists for a transmitter or group of transmitters, in transmitting a packet intended for a group of clients in a multicast transmission mode. In this mode, the packets are sent to an address known as multicast broadcast address and will be routed to all the recipients belonging to the broadcast group. A client that joins a broadcast group is said to subscribe to the group and a client that leaves the group is said to unsubscribe from the group.

The multicast broadcast is use in practice to save on the intermediate bandwidth in the network when a source sends data to a group of recipients, such is the case when live TV services are broadcast. Indeed, in this case, the use of a point-to-point transmission mode means that the data is sent as many times as there are recipients. This mode leads to the duplication of packets on the parts of the network common to the paths between the source and the different recipients. On the contrary, the multicast broadcast enables the data to be sent only once, this data being duplicated on the routers of the network, according to the paths leading to the recipients belonging to the broadcast group.

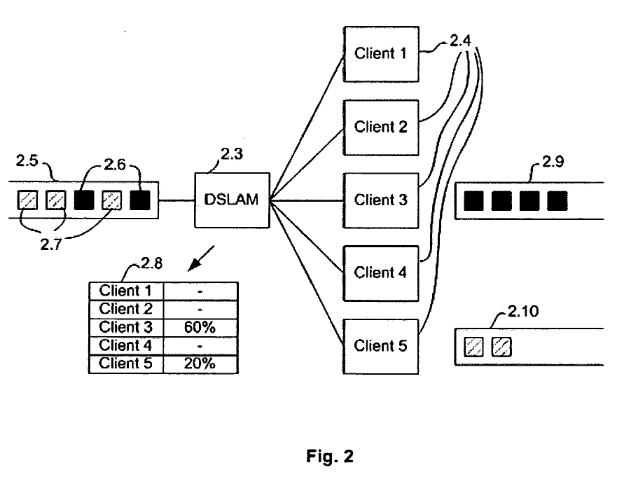

FIG. 2 shows more precisely, the operation of the distribution of the video stream coming from servers via a distribution network to client in the embodiment of the invention. This figure focuses on what happens at the level of the client and the DSLAM. The clients referenced 2.4 and numbered from 1 to 5 are connected to a same DSLAM referenced 2.3. The figure also illustrates the input buffers referenced 2.9 and 2.10 of the clients 3 and 4. The data referenced 2.5 arriving from the servers via the distribution network on the DSLAM comprise two data streams. A first data stream of which the packets, referenced 2.6, in black is intended for the client 3 while the second stream of which the packets, referenced 2.7, is intended for the client 5. One therefore logically finds black data packets in the buffer 2.9 of client 3 and white packets in the buffer 2.10 of the client 5. The DSLAM 2.3, besides its management role of the ADSL connection between the client and the network acts as a first level router between the clients and the network. All the traffic between the distribution network and the clients that it connects therefore passes through it. In the downward direction, it receives all the data packets, real-time and other, of the network via its interface with the network and distributes them to the recipient clients. In the upward direction, it receives all the packets sent by the clients and retransmits them over the network. Within the framework of the embodiment of the invention, it will contain the table references 2.8, the function of Which will be described further on.

The clients are typically digital television decoders in the embodiment, but they may be any device enabling the recovery of real time content, such as a digital television, a digital hi-fi system or other device. These clients thus consume the content data packets in the buffer to recover the content. The rate of consumption is set by the speed of recovery. The MPEG standard provides, for example, for the presence of time stamps known as PTS (Presentation Time Stamp) inserted regularly into some data packets and defining the moment at which the associated data must be presented hence recovered by the client. This associated data is typically images for the video and sound sample for the sound. Respecting the real time and the correct recovery of the content therefore requires these PTS to be respected and the display of the data at the scheduled moment.

If the data packets coming from the network do not arrive quickly enough in the input buffer of the client, said client can empty and arrive at an underflow situation. In this case, the client is no longer able to respect the real-time constraints and to recover the data at the scheduled time, a service interruption occurs. If the content is video, images will be missing and the user will perceive a black screen or the freezing of the image according to the manner in which the client will react to the lack of information. There can be many causes of such a situation. It may involve a server subjected to too great a demand that is no longer able to supply its data. It may also involve a congestion in the network slowing down or even losing some data packets. On the other hand, an overflow of the input buffer can also occur. In this case data packets will be received by the client that the said client will not be able to store. These packets will be lost. These missing packets will then cause interruptions in service through lack of data. These overflows can, for example, come from the grouped reception of a great number of packets or from a poor synchronisation between the server and the client.

It is therefore important for the quality of the service perceived by the user to avoid, as far as possible, these underflow and overflow situations. A known solution consists in overdimensioning the distribution network to prevent congestion and enable a fluid and the least disturbed as possible circulation of the data packets. This solution naturally raises the problem of the cost and cannot be used in all cases. On a more fairly dimensioned network, it is not possible to guarantee that the underflow or overflow situations cannot happen. In this case, a predictive detection of these situations can trigger a warning. This warning can be recognised to start actions limiting the problems linked with service interruptions.

There are systems, like the one described in the document JP09298734 where a surveillance unit of the filling rate of the buffer is implemented on the client. When an underflow or an overflow is ready to occur, it is then possible for the client to send a warning message to the server. The server then adapts its data transmission rate to prevent the underflow or overflow from occurring. This solution poses two main problems. On the one hand, it involves message exchanges on the network between the client and the server. These exchanges introduce a latency in the reaction of the server and therefore in the correction made. On the other hand, the correction coming from an adaptation of the server can only operate if the distribution of the data is carried out by the server for the exclusive destination of a single client. Indeed, all the clients of a same content not having the same filling rate of their input buffers, it is not possible to control the transmission to suit all the clients.

The solution proposed in the embodiment of the invention consists in a surveillance of the filling rate of the input buffers of the clients. This surveillance is made upstream of the clients in the network. It can, for example, be carried out at the level of the DSLAM. In such a manner as to be able to initialise this surveillance, the DSLAM must know for the clients to which it is connected and of which it will survey the buffers, the size of its input buffer, as well as the quantity of data that the decoder will store before starting the decoding. It is possible to design the communication by the client of the size of its buffer to the DSLAM as well as the initial storage quantity. There are several ways in which to carry out this communication. In the case of an implementation of the invention on the DSLAM, the simplest is to integrate this transmission into the exchange of messages initialising the connection. Indeed, the connection is set up between the client and the DSLAM by using a point-to-point link protocol such as PPPoE (Point to Point Protocol over Ethernet), PTP (Point to Point Tunneling Protocol) or even PPPoA (Point to Point Protocol over ATM). All these protocols integrate a preliminary parameter negotiation phase, the size of the input buffer and the quantity of initial storage can be added to the parameters exchanged during this phase.

It is also possible to provided for a request by the DSLAM to request the information from the client, or even the input of this parameter in the DSLAM by the administrator of the distribution network and therefore of the DSLAM, or any other method enabling the DSLAM to acquire this information.

Once the DSLAM has the information on the size of the buffer of the client and the quantity of data stored before the triggering of the decoding, it is possible to estimate the filling rate of the input buffer of the decoder. Indeed, the DSLAM, owing to the fact that it is located on the last link between the network and the client, has the knowledge of all the data received by the client. It knows the decoding speed and therefore the consumption of the data by the client. This information can be deduced from the stream or be part of the parameters that the client sends to the DSLAM. This information depends on the type of real-time data stream sent, on its compression rate and its encoding. The estimation is made in two phases, initially the decoding is not started on the client. The buffer therefore fills up with data sent by the DSLAM, without consumption. Once the quantity of data sent has reached the initial storage quantity, the decoding and therefore the consumption. of the data begins on the client. A second phase is then entered. In this second phase, the DSLAM estimates the filling rate of the buffer by a calculation of the data that has been sent to the client less the data consumed. The DSLAM can in this manner keep a table, as illustrated in FIG. 2, and referenced 2.8, giving for all the clients the filling rate of the input buffer. Hence, on FIG. 2, the table 2.8 is used to see that the input buffer of the client 3 is filled to 60%, whereas the buffer of client 5 is filled to 20%. The clients 1, 2 and 4 do not receive real-time content flows. The DSLAM can therefore determine at any moment the filling rates of the input buffers of the clients receiving a flow of real-time content and this without involving message exchanges between the DSLAM and the clients. The calculation of the estimation of the filling rate of the buffers must be done regularly. It can be done for each packet sent to the client or in a regular manner. During the first phase, the filling rate of the buffer corresponds to the quantity of data sent to the client. During the second phase, this rate corresponds to all the data sent less the data consumed.

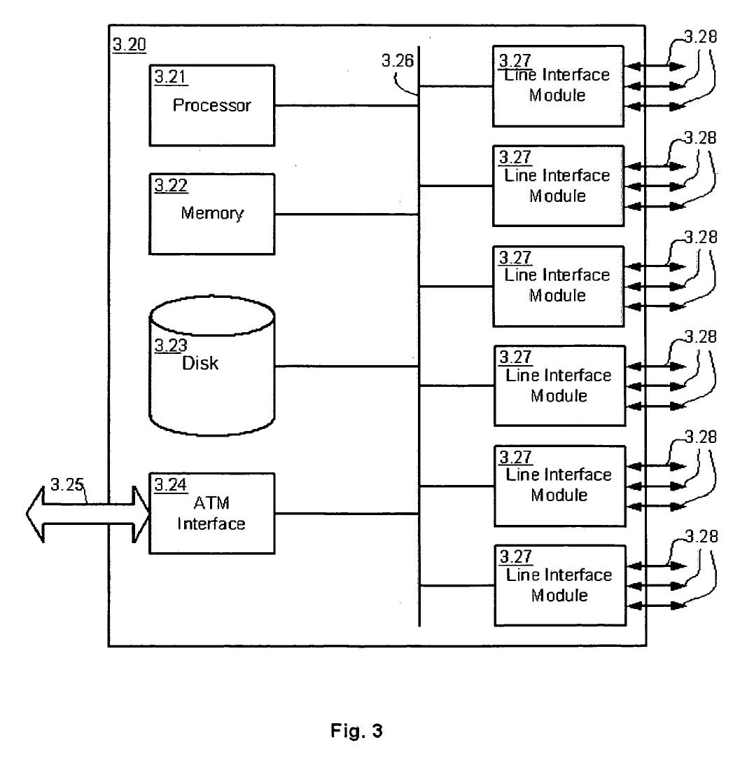

This knowledge being acquired, it is now possible for the DSLAM to know when one of the clients will be in overflow or underflow. One can, for example set the thresholds triggering a warning. One can, for example, set these thresholds to 5% and 95% and trigger the warning when the filling rate is less than 5% or greater than 95%. This knowledge can trigger a warning or corrective actions. One embodiment of the invention provides, for example, that the DSLAM contains video sequences pre-recorded or generated on the fly, these sequences being able to be stored in memory or on disk, referenced 3.23 in FIG. 3, within the DSLAM. In the case of underflow, it is possible to send the client data packets of such a pre-recorded sequence instead of the missing packets for the programme that it is receiving. The user will therefore perceive an interruption in his programme during which he will view a replacement or substitution sequence that can be, for example, programme announcements, a specific message relating to the transmission condition of the required content, advertising sequences or any type of sequence that one could wish to make available to him. The impact will likely be less negative than a “black screen” or a frozen image.

The architecture of such a DSLAM according to the invention is illustrated in FIG. 3. The surveillance device, referenced 3.20, contains a processor referenced 3.21 enabling the execution of the processing operations, a working memory referenced 3.22 for the storage of data such as the table 2.8, a storage memory referenced 3.23 being able to be a disk and enabling, for example, replacement sequences to be stored according to a particular embodiment of the invention. The device has an interface referenced 3.24 linking it to the content distribution network by means of a link referenced 3.25. In the embodiment, this link and this interface are ATM links (Asynchronous Transfer Mode), but this can also be for example the Ethernet Gigabit. On the other hand, a series of line interface modules referenced 3.27 each enable ADSL connections referenced 3.28 to be set up with the clients, typically 16, by the telephone line. These modules, the processor, the memory, the disc and the interface with the distributions network communicate by an internal bus referenced 3.26. The communications between the distribution network and the clients are therefore mixed on the link 3.25 and distributed on the links 3.28 according to the client involved.

In the case of overflow, it can be provided that the DSLAM stores in a buffer that is specific to it the data that the client can no longer receive. This data will be sent to it delayed when the filling rate has reduced.

It is also possible to provide for the sending of explanatory messages to the client. One can also provide warning messages sent to a supervision of the distribution network. In this manner, the administrators of the distribution network can measure the quality of the service provided and resolve the problems appearing in the distribution of the services. It is possible to maintain statistics on the service distribution incidents so as to dimension the distribution network in a better manner.

The embodiment of the invention describes an implementation within the DSLAM of the invention, but said invention can be implemented on other devices, or even be implemented on a device connected on the link arriving at the DSLAM or on the link between the DSLAM and the client. The only necessary condition being to implement the invention within the network at a point that sees passing through all the data intended for the destination of the client so as to enable a reliable estimation of the data that said client receives. The invention can, for example, be implemented on a device connected on the link upstream of the DSLAM and operating as a sensor analysing the traffic on the link. Likewise, the embodiment is positioned in the case of a connection by ADSL of the clients but can just as well operate irrespective of the connection mode and can be implemented, for example, on a cable head end in the case of a cable connection, or on a wireless access point in the case of a wireless connection between the client and the distribution network.

1. Device that can be connected to a content distribution network by packets, the content being sent in the form of a stream of digital data intended for at least one client, the at least one client having an input buffer in which it stores the data received before decoding it with a view to recovering the content the device having means to transit the data packets between the distribution network and the at least one client, connected to the said distribution network, these means to transit data packets transiting all the packets intended for the buffer of the client, wherein the device comprises:
calculation means of an estimation of the filling rate of the input buffer of the at least one client according to at least one parameter of the said client, taken from among the following parameters:
the size of the input buffer of the at least one client connected to the distribution network,
the quantity of data that the at least one client stores before triggering the decoding when it receives a data stream,
the recovery bit-rate that the at least one client uses to empty the input buffer,
and means to send a content replacement sequence to a client when the estimated filling rate of the input buffer of the said client crosses below a threshold.

2. Device according to claim 1, also comprising storage means for real-time content replacement sequences.

3. According to claim 1, suitable to temporarily store the data packets intended for a client for which the estimation of the filling rate of its input buffer crosses above a second threshold.

4. Device according to claim 1, suitable to send a warning message when the estimation of the filling rate of a client crosses below a third threshold.

5. Device according to claim 1, suitable to send a warning message when the estimation of the filling rate of a client crosses above a fourth threshold.

6. Device according to claim 1, wherein it is of the Digital Subscriber Line Access Multiplexer type.

7. Method for estimating the filling rate of the input buffer of a decoding device of a content sent in the form of a stream of digital data, called client, by a surveillance device that can be connected to a content distribution network by packet switching, the surveillance device having means to transit the data packets between the distribution network and the client connected to the said distribution network, these means to transit data packets transiting all the data packets between the client and the distribution network, wherein the method comprises at least the following steps:
the calculation of an estimation of the filling rate of the input buffer of the at least one client according to the size of its input buffer, the quantity of data that it stores before triggering the decoding and the data packets having transited through the said surveillance device intended for the at least one client.
and the sending of a content replacement sequence to a client when the estimated filling rate of the input buffer of the said client crosses below a threshold.

8. Method according to claim 7, wherein the calculation of the estimation of the filling rate is carried out in a regular manner.

9. Method according to claim 7, wherein the calculation of the estimation of the filling rate is carried out each time a data packet is sent to the client.

10. Method according to claim 7, moreover comprising a step for temporarily storing the data packets intended for a client for which the estimation of the filling rate of its input buffer crosses above a second threshold.

11. Method according to claim 7, moreover comprising a step of sending a warning message when the estimation of the filling rate crosses below a third threshold.

12. Method according to claim 7, moreover comprising a step of sending a warning message when the estimation of the filling rate of a client crosses below a fourth threshold.
